(19) United States
(12) Patent Application Publication
(10) Pub. No.: US 2021/0334753 A1
(43) Pub. Date: Oct. 28, 2021

(54) SYSTEM FOR MANAGING ENTERPRISE DATAFLOWS

(71) Applicant: Richard Catalano, Little Rock, AR (US)

(72) Inventor: Richard Catalano, Little Rock, AR (US)

(21) Appl. No.: 16/859,112

(22) Filed: Apr. 27, 2020

(51) Int. Cl. G06Q 10/10; G06Q 10/06; G06N 20/00

(52) U.S. Cl. CPC G06Q 10/103; G06Q 10/06312; G06Q 10/063118; G06N 20/00; G06Q 10/107; G06Q 10/063114; G06Q 10/0633; G06Q 10/06316

(57) ABSTRACT

A system for managing organization dataflows is disclosed, comprising a database configured to store a plurality of data related to a project scope, personnel, and historical data. An artificial intelligence system receives the plurality of data provide the plurality of data to a machine learning module to determine one or more suggested steps for completing the project. A scheduling module in operable communication with the machine learning module to receive scheduling information and compare the scheduling information with the historical data to determine a timeframe for completing the project for at least one of a plurality of users.

### TECHNICAL FIELD

The embodiments generally relate to systems for monitoring and managing resources for dataflow in an enterprise and, more specifically, relate to enterprise workflow management and resource allocation using a computerized system.

### BACKGROUND

Enterprises often receive and transmit a large amount of information using various systems, which may or may not have the capability to communicate with one another. Each system used by the enterprise may require a digital transformation to be implemented in a computerized system accessible by the various parties in communication with the enterprise. Often, there is a disconnect between the various parties involved in a workflow. For example, in a largescale workflow at an enterprise, various parties can include enterprise executives, third-party executives, business process analysts, consultants and subject matter experts, consulting practice executives, program leads, project managers, application and technology experts, production specialists, organizational transformation professionals, deployment specialists, data migration and integration professionals, and testing professional to name a few. Each party may comprise numerous sub-roles, which each require various degrees of access to information flow throughout a project. These largescale workflows produce high volumes of information which must be accurately and efficiently disseminated to the parties that require the information throughout the lifespan of the project.

Inadequate communication between each party may result in wasted resources and misallocation of information due to the large number of documents being created over various platforms by each user within the enterprise workflow. To manage various documents, file server systems are used, such as Microsoft Sharepoint and similar systems which offer real-time collaboration and simultaneous operations to be performed on various document types; however, the system does not necessarily account for the downstream impact to other parties involved in the information being changed. This is especially concerning when numerous teams are processing changes to information in a disconnected manner.

In the current arts, organization personnel analyze and aggregate data from various sources while spending large amounts of resources determining the current state of a project. For example, data may be pulled from financial management systems, software testing systems, project management systems, defect detection systems, and the like. In order for a high-level picture of a project to be ascertained, each party must submit data which is analyzed and aggregated before the next steps of a workflow are ascertained. This requires in-depth knowledge of process steps, goals, and the personnel associated thereto.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a system for managing organization dataflows, comprising a database configured to store a plurality of data related to a project scope, personnel, and historical data. An artificial intelligence system receives the plurality of data to provide the plurality of data to a machine learning module to determine one or more suggested steps for completing the project. A scheduling module is in operable communication with the machine learning module to receive scheduling information and compare the scheduling information with the historical data to determine a timeframe for completing the project for at least one of a plurality of users.

The system utilizes artificial intelligence and machine learning subsystems to interpret information related to an event, project, or task thereof and generate an output including suggested steps for the completion of the event, project or task. Further the system may predict a timeframe for the task completion for one or more users of the system. In such, the system allows for users (e.g., project managers) to receive suggestions for steps and personnel related to an event, project, or task. The system facilitates workflow optimization throughout an organization and auxiliary parties working on an event, project, or task.

In one aspect, a project completion module receives information related to a project, determines one or more suggested steps for completing the project, and determines at least one task required to complete the project.

In one aspect, a task completion module receives information related to a task and determines one or more suggested steps for completing the task.

In one aspect. a content manager receives the plurality of data and distributes the plurality of data to a distribution engine.

In one aspect, the distribution engine determines one or more outputs for the content, wherein the outputs include at least one of the following: one or more webpages, one or more media outlets, and one or more email systems.

In one aspect, the plurality of users each perform one or more tasks during a project.

In one aspect, a project management system receives status updates for each of the one or more tasks and transmits an output, via a communications engine in operable communication with a communications application.

In one aspect, the artificial intelligence engine provides a template for information transmitted by the communications application.

In one aspect, the plurality of data includes a priority level assigned to the project, wherein the priority level is analyzed by the artificial intelligence engine to determine the timeframe for completing the project.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the system infrastructure, according to some embodiments;

FIG. 3 illustrates a schematic of the information presentation system, according to some embodiments;

FIG. 4 illustrates a schematic of the information presentation system and data access system, according to some embodiments;

FIG. 5 illustrates a schematic of the workflow system, according to some embodiments;

FIG. 6 illustrates a schematic of the parties associated with the organization and in communication via the network, according to some embodiments;

FIG. 7 illustrates a block diagram of the artificial intelligence subsystem, according to some embodiments;

FIG. 8 illustrates a block diagram of the artificial intelligence engine, according to some embodiments;

FIG. 9 illustrates a block diagram of the machine learning engine, according to some embodiments;

FIG. 10 illustrates a schematic of the content manager, according to some embodiments;

FIG. 11 illustrates a block diagram of the information resources subsystem, according to some embodiments;

FIG. 12 illustrates a block diagram of the project management subsystem, according to some embodiments;

FIG. 13 illustrates a block diagram of the prediction subsystem, according to some embodiments;

FIG. 14 illustrates a block diagram of the communications engine, according to some embodiments;

FIG. 15 illustrates a flowchart for a process for managing a workflow, according to some embodiments; and

FIG. 16 illustrates a flowchart for a process for managing personnel associated with a workflow, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the system described herein relates to a computer system utilized to manage workflows in an enterprise. The system includes artificial intelligence and machine learning subsystems to interpret information related to an event, project, or task thereof and generate an output including suggested steps for the completion of the event, project, or task. Further the system may predict a timeframe for the task completion for one or more users of the system. In such, the system allows for users (e.g., project managers) to receive suggestions for steps and personnel related to an event, project, or task. The system facilitates workflow optimization throughout an organization and auxiliary parties working on an event, project, or task.

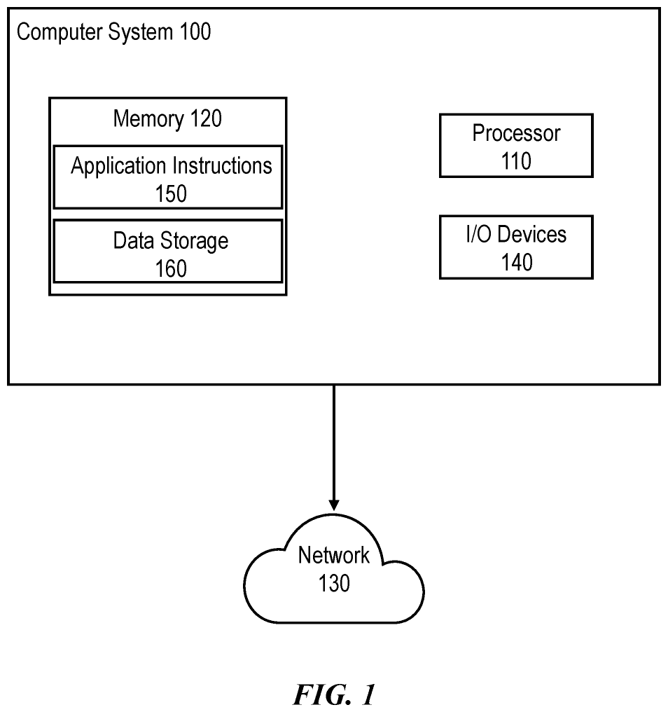

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

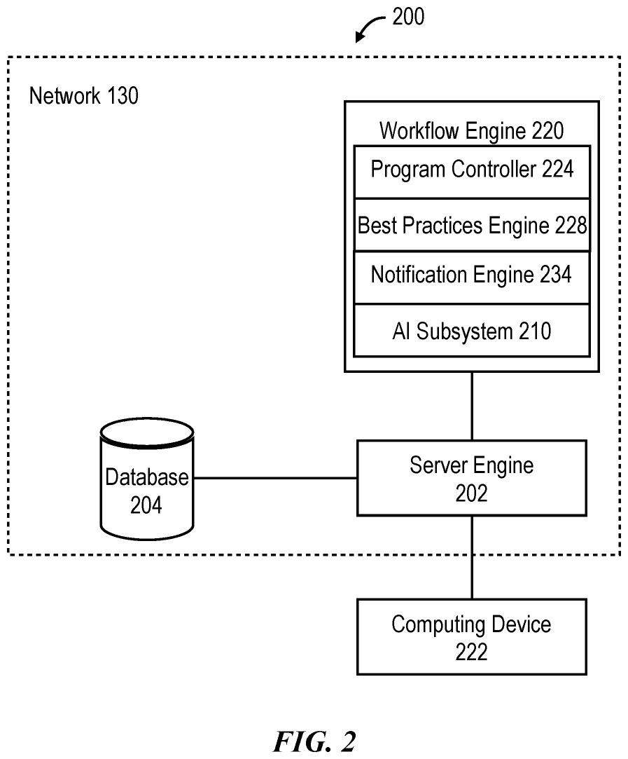

FIG. 2 shows a system 200 including a server engine 202, database 204, workflow engine 220, notification engine 234, a graphical user interface (GUI) presenter 214, and an artificial intelligence (AI) subsystem 210. Each of these system components resides in a networked system, which may be a “cloud” system, and communicates with other system components, which may reside in a single server. Alternatively, these components may be housed in a single server or network of servers. The server engine 202 communicates to one or more user computing devices 222, which may take the form of various computing devices known in the arts (i.e., a computer, smartphone, or tablet).

The user devices 222 have a display capable of displaying a graphical user interface (GUI), which is provided to the user device by the server engine 202 and which permits users to provide data for use or storage by the system 200; receive alerts, notifications, requests for data, historical data, and other information from the system 200; and otherwise interact with the system 200. According to a preferred embodiment, the server engine 202 has an administration subsystem that requires a user to undergo an authentication process (or log in process) in order to access the system 200. The system may provide user permissions to each user allowing for partial access to system functionalities, databases, and general permissions known in the arts.

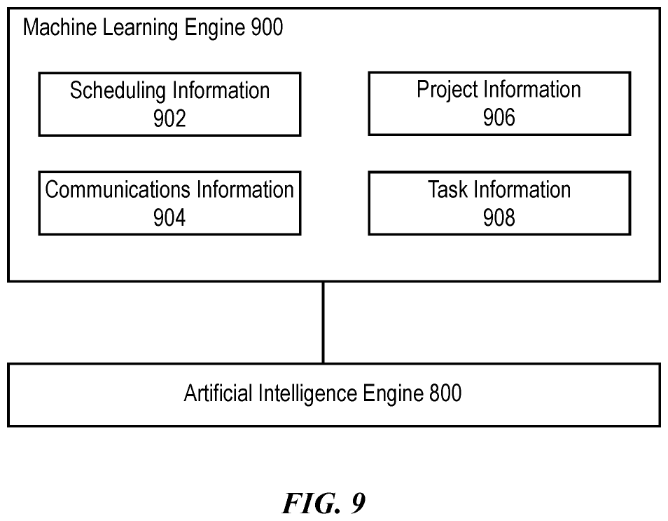

A program controller 224 in the workflow engine 220 transmits information from the database storage 204 through the use of a machine learning engine 900 (see FIG. 9), which may be based upon a commercial artificial intelligence (AI) subsystem 210. The machine learning engine monitors inputs to the system and monitors associations between inputs and historical data stored in the database 204. The machine learning engine 900 (see FIG. 9) also receives and executes pre-defined rules customized for the creation of system objects (e.g., projects, tasks, personnel) and variables associated with those objects, and the execution and association of objects with one another. These pre-determined rules may be continuously improved by experts to create best practices with the assistance of the machine learning engine. The machine learning engine analyzes data corresponding to the input and creation of tasks and the results thereof and identifies associations between inputs and positive and/or negative results. The results of this analysis and identification are stored by the machine learning engine as optimized parameters for each action taken by a user in connection with the project management. When a user executes any action within the system, the program controller 224 in the server engine 202 runs a best practice engine 228 that searches the database 204 for the optimized parameters generated and stored by the machine learning engine. The best practices engine 228 reads the optimized parameters from the database 204 and displays such parameters on the GUI of the user device as recommended best practices for a particular action.

The machine learning engine is also capable of generating information for use with forecasting and optimizing decisions (including allocation of tasks). The system database 204 contains all relevant information pertaining to the tasks that have been and are to be performed, how the tasks were performed, and by what resources the tasks were performed and managed. The machine learning engine is capable of analyzing this information to develop associations between the information and generate forecasts corresponding to, among other things, task completion, resource utilization, and financial inlays and outlays. As additional information is provided to the system, the machine learning engine continually updates and improves its ability to forecast what is likely to happen with respect to the selection of a particular parameter for a particular action (e.g., the assignment of a particular resource to a particular task), and can therefore determine, for example, the best resources to allocate for each task, which resources are likely to work best together for completion of a particular task, how long each kind of engagement, project, or task will take, and forecast demand for services.

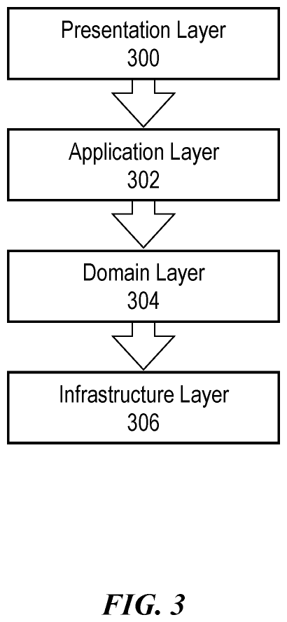

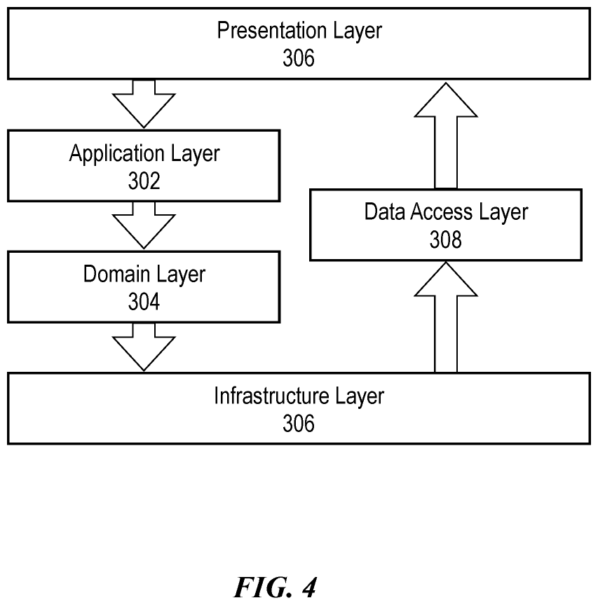

FIG. 3 illustrates a model for processing functionalities provided between a presentation layer 300, an application layer 302, a domain layer 304, and an infrastructure layer 306. Similarly, FIG. 4 illustrates the presentation layer 300, application layer 302, domain layer 304, and infrastructure layer 306 including a data access layer 308 to distribute data from the infrastructure layer 306 to the presentation layer 300. The presentation layer 300 includes views and presentation templates to generate the application layer 302. The domain layer 304 defines organization rules and logic and includes domain models to define best practices of the organization, project, and/or task.

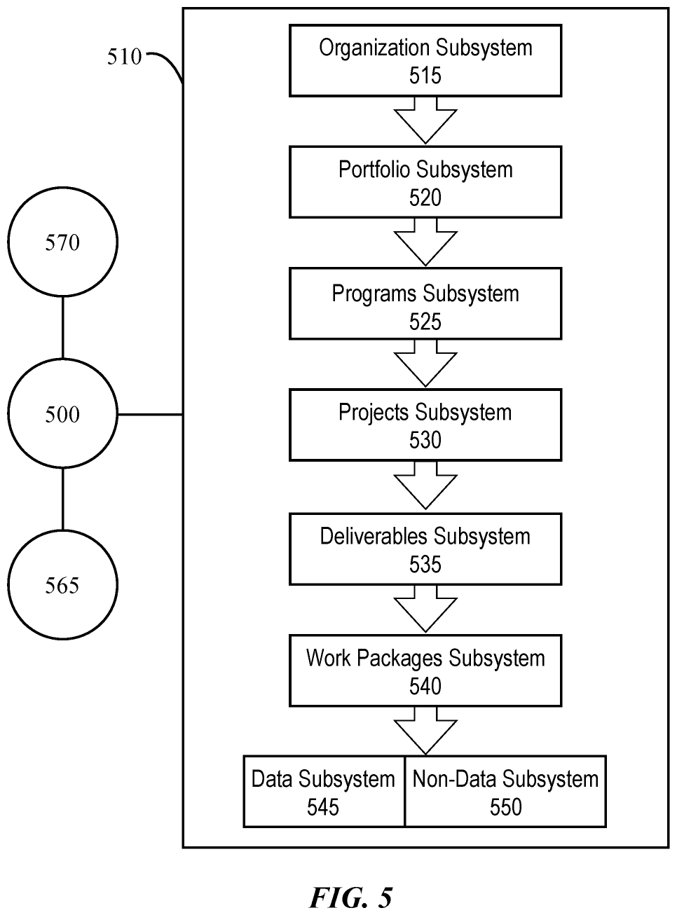

FIG. 5 illustrates a schematic of the platform matrix 500 including the control subsystem 505 in communication with the workflow hierarchy 510 comprising the organization subsystem 515, portfolio subsystem 520, programs subsystems 525, projects subsystem 530, deliverables subsystem 535, work packages subsystem 540, data subsystem 545, and non-data subsystem 550. An integration subsystem 565 receives data from each component of the workflow hierarchy 510 and outputs information to the platform matrix 500. Work items 570 are received from users in communication with the organization and are transmitted to the platform matrix 500. The platform matrix 500 allows for the management of risks, actions, issues, key decisions, changes, organizational knowledge, project knowledge, quality, and communications within the system.

The organization subsystem 515 receives, transmits, or otherwise interacts with organization data, including goals, visions, etc. of the organization to provide information to efficiently complete tasks related to the organization. The portfolio subsystem 520 may receive, transmit, or otherwise interact with information related to projects which are in progress, completed, or planned. The portfolio subsystem may communicate with a programs subsystem 525 to ensure communication between various programs during a task. The projects subsystem 530 may receive, transmit, or otherwise interact with project data provided by the various components of the workflow hierarchy 510 to ensure efficient completion throughout the lifespan of a project, and in view of the plurality of projects engaged with by the organization.

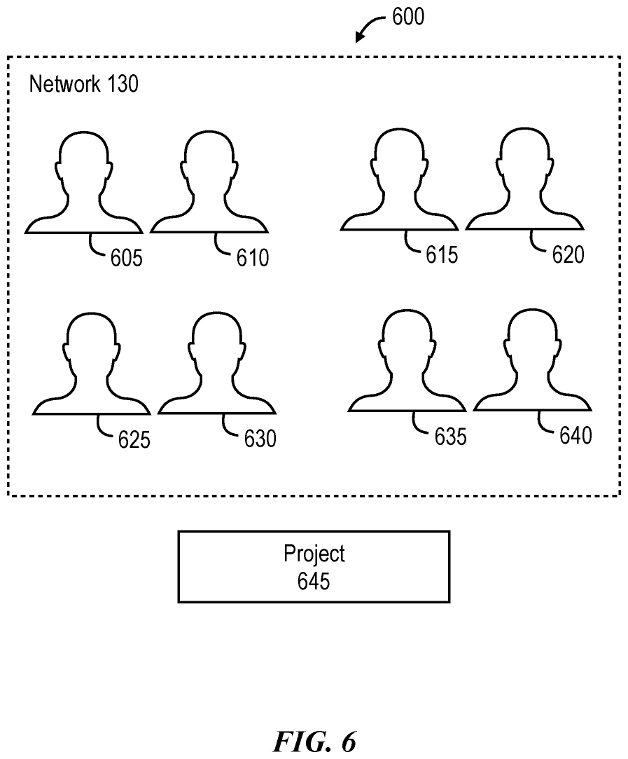

FIG. 6 illustrates a schematic of the plurality of parties in communication via network 130 with the organization system 600 in an exemplary embodiment. The parties may include business process analysts 605, application technology experts 610, consulting practice personnel 615, production specialists 620, executives 625, organizational transformation professionals 630, deployment specialists 635, and program personnel 640. Each party performs a subset of tasks related to a project 645. The tasks performed by each party are transmitted to the system wherein they are analyzed and processed to permit the system to suggest suitable next steps of the project in view of information received from each party.

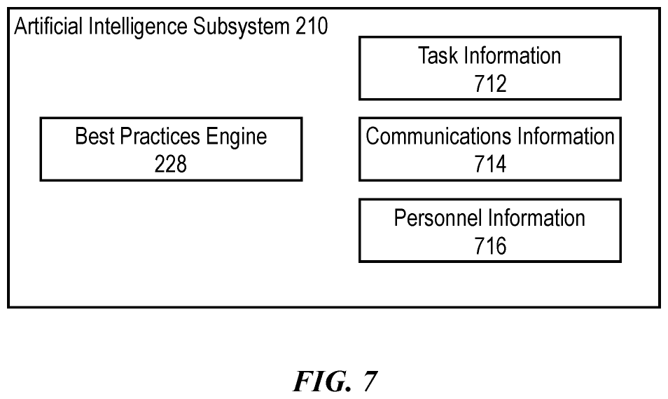

FIG. 7 illustrates a block diagram of the artificial intelligence subsystem 210 which receives digital information and processes the digital information to produce a plurality of outputs including suggested tasks, suggested personnel to complete the task, and estimated completion dates and/or times. Once the artificial intelligence subsystem 210 receives digital information, such as task information 712, communications information 714, and personnel information 716 or other forms of digital information, the artificial intelligence system processes the information in references to the best practices engine 228 which informs the artificial intelligence subsystem 210 of approved means for completing a task, means for completing a task which have been used before, or optimized suggestions for completing the task. For example, the artificial intelligence subsystem 210 receives a completed task notification and utilizes the best practices engine 228 to determine potential next steps in the process of completing a project. The artificial intelligence subsystem 210 may analyze a listing of employees, contractors, or the like who are available to complete the task, as well as the estimated timeline for the task completion depending on the task details and assigned users' propensity for completing the task in a given timeframe. For example, the system may determine that a first user is likely to complete the task in 5 days, while a second user is likely to complete the task in 7 days.

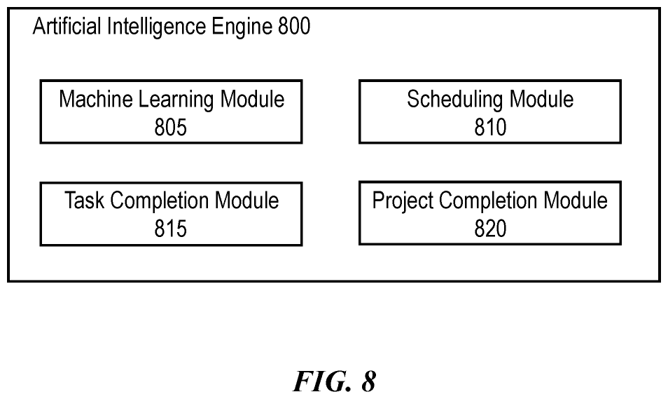

FIG. 8 illustrates a block diagram of the artificial intelligence engine 800 and modules associated thereto. The artificial intelligence engine 800 is in operable communication with a machine learning module 805, a scheduling module 810, a task completion module 815, and a project completion module 820. The machine learning module 805 utilizes received digital information, such as task information, and searches whether optimized parameters for completing the task, task scope, and task steps exist. If so, the machine learning module 805 displays the information to the user. If no optimized parameters exist, the machine learning module 805 will attempt to suggest task steps, task information, and task parameters to the user in view of the identified task details and scope. The user may be prompted to review the suggested information. The scheduling module 810 receives schedule information from the users and utilizes the scheduling information to calculate plausible timeframes for completing a task. The scheduling module 810 may be in communication with the machine learning module 805 to receive historical data related to completed tasks or projects to generate an estimated completion time. The task completion module 815 may determine a plurality of steps and step orders for completing a task in view of the project for which the task is completed. Similarly, the project completion module 820 may determine a plurality of tasks and order thereof which are required to complete a project.

In some embodiments, if the machine learning module 805 is unable to identify optimized parameters for a particular task, the user may be prompted to enter all required data concerning the formal task scope and detailing exactly what has to be done to complete the task. The machine learning module 805 may create a template for future similar tasks, or alternatively, user may create such a template that includes portions or all of the details for particular types of tasks outside of the project creation process.

The embodiments may utilize predictive models for determining the time-to-completion for a particular task, determining steps to complete a task or project, determining communication steps during the execution of a task or project, and the like. Specifically, machine learning is applied to a set of historical data for the past projects to obtain optimized steps and personnel to complete the steps for each task, project, or the like.

In some embodiments, a predictive analytics model enables prediction of timeline and status of one or more next project events in a project based on current history of milestone activity in the lifecycle of the project. The predictive analytics model may also be used to monitor the progress/status of a project. In one embodiment, the predictive analytics model may automatically learn a reasonable plan from historical data by determining a normal speed of attaining a successful outcome and identifying patterns representing progress, and predict a reasonable time interval and interim milestones, without pre-defined plans or pre-defined routines.

FIG. 9 illustrates the machine learning engine 900 which receives digital information from the users and the components of the artificial intelligence engine 800. The machine learning engine 900 utilizes scheduling information 902, communications information 904, project information 906, task information 908, and the like to generate suggestions for steps and personnel as described hereinabove. Once the suggestion is generated, the suggestion information is transmitted to at least one user for review.

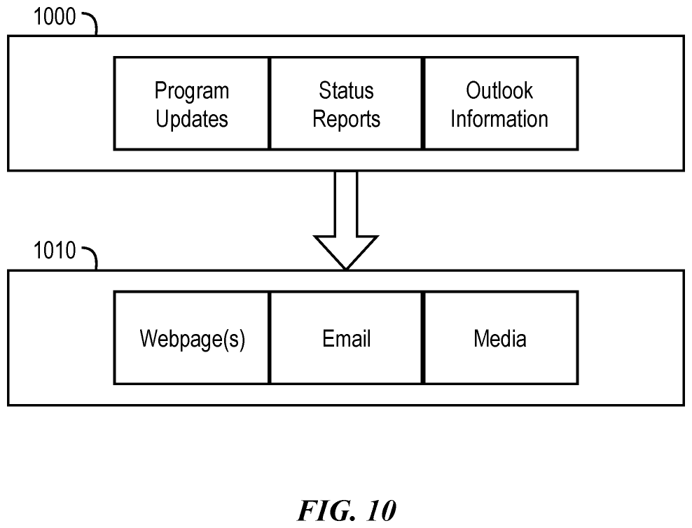

FIG. 10 illustrates a schematic of the content manager 1000 and distribution engine 1010 enabled to receive information from the various components of the system and transmit the information to users via a plurality of distribution methods. The content may include program information (e.g., program updates, status reports, and program outlook information), communication information, visual information (e.g., slideshows, charts, etc.), and the like. The distribution engine 1010 determines a suitable means for delivering content, such as via websites, emails, media outlets, in print, meetings, and the like.

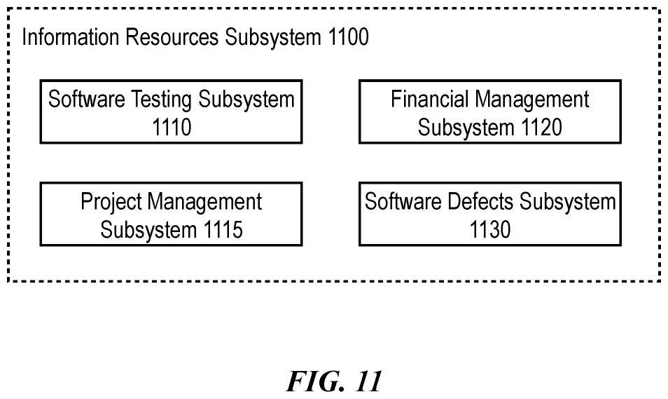

FIG. 11 illustrates a block diagram of the information resources subsystem 1100 utilized by various users of the system. The subsystems may be auxiliary services provided by service providers or may be proprietary systems utilized by the organization. A project management subsystem 1115 provides project management information to the system, such as active, historical, and future project data, status, and likewise information. A software testing subsystem 1110 transmits and receives information related to testing protocols, test results, test scheduling and similar information. One skilled in the arts will readily understand that the software testing subsystem 1110 may include non-software product testing information. A financial management subsystem 1120 transmits financial information to the system 100. A software defects subsystem 1130 receives software defect information and may transmit the software defect information to the system 100.

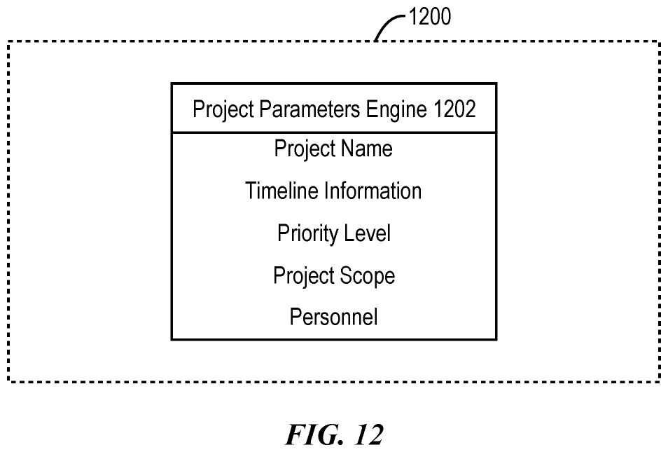

FIG. 12 illustrates a block diagram of the project management subsystem 1200 comprising a project parameters engine 1202 which receives the project characteristics including project name, level of priority, project scope, project timeline information, and personnel associated with the project. The project parameters engine may then create a project scope, a project timeline, and suggested personnel for completing the project. The project management subsystem 1200 aggregates information from the system and provides an output to one or more users for one or more steps throughout the lifespan of the project. The project management subsystem 1200 may prioritize tasks within a project, prioritize projects in view of other projects an organization is completing, and the like.

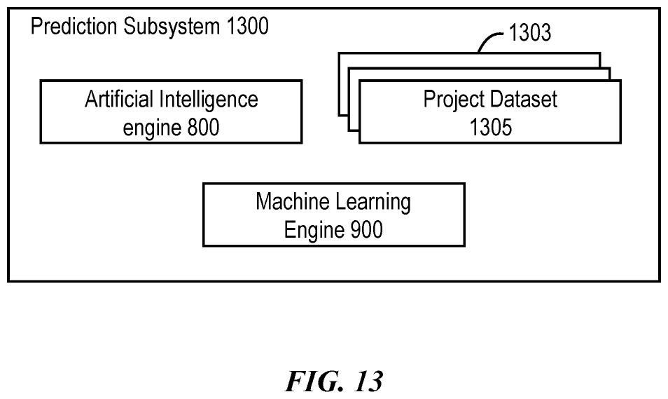

FIG. 13 illustrates a prediction subsystem 1300 including a plurality of historical data 1303 comprising a plurality of project data sets 1305 utilized by the artificial intelligence engine 800 and machine learning engine 900. The prediction subsystem 1300 predicts potential outcomes of various tasks, projects, and events using the historical data for similar projects. A comparator compares received project and task details with historical data sets to facilitate the identification of similar projects, tasks, and the outcomes thereof.

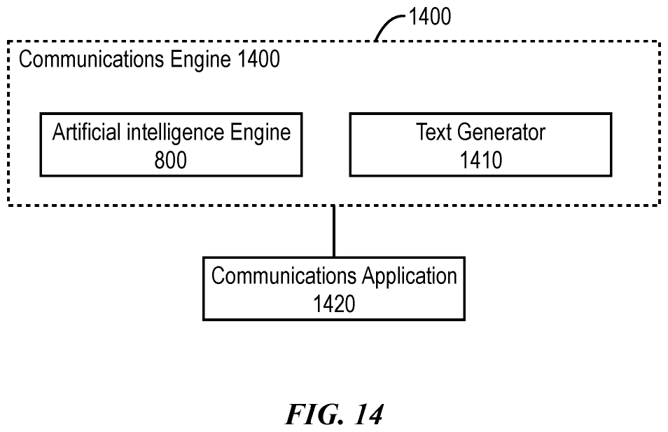

FIG. 14 illustrates a communications engine 1400 which receives information produced by users of the organization and generates a communication from a first user to a second user. For example, the communications engine 1400 receives a project status update from a first user resulting in the delay of the project due date. The communications engine 1400 may then generate a communication (e.g., an email) via a text generator 1410 to a second user, via a communications application 1420, who is involved in the project, task, or downstream process to alert the second user of the delay. In another example, the communications engine 1400 receives information related to a deficiency in a task item following a software test. The communications engine 1400 may generate a communication to a one or more users of the system to alert the users of the deficiency.

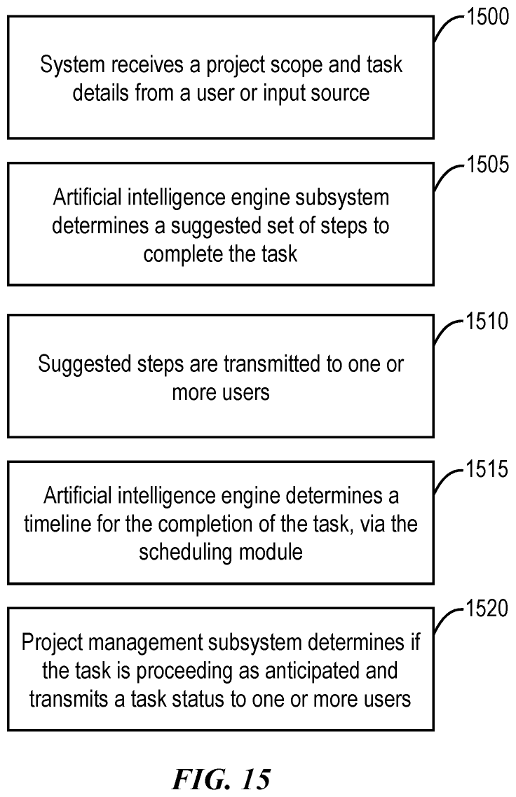

FIG. 15 illustrates a process for completing a task utilizing the system described hereinabove. In step 1500 the system receives a project scope containing task details from a user or other input source. The artificial intelligence engine 800 determines a suggested set of steps to complete the task in step 1505 and transmits the suggested steps to one or more users in step 1510. In step 1515, the artificial intelligence engine 800 may also determine a timeline for the task completion for one or more users of the system by consulting the scheduling module 810 to determine availability, workload, and historical data related to each user. In step 1520, the project management subsystem 1200 determines if the project is proceeding as anticipated or if indications, communications, or other information has been received which may indicate that the project status and estimated completion differs from an expected state. If it is determined that the project is not proceeding according to the initial prediction, one or more communications may be sent to one or more users alerting them of the change. Once the project, task, or the like is completed, the information related thereto including steps taken, timeline, personnel, and the like is stored in the database and may be referenced in future events.

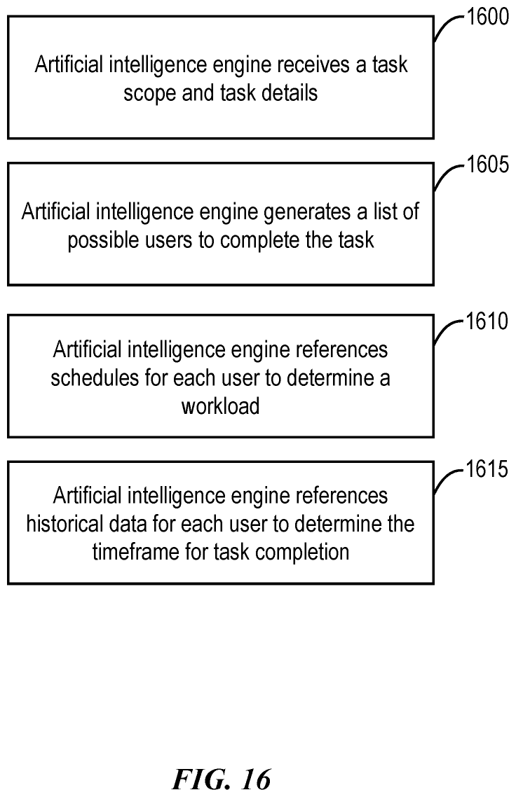

FIG. 16 illustrates a process for estimating a timeframe for completing a task by one or more users of the system. In step 1600 the artificial intelligence engine 800 receives a task scope containing task details from a user or other input source and generates a listing of possible users to complete the task in step 1605. The artificial intelligence engine 800 may then reference schedules of each user via the scheduling module 810 to determine the workloads of each user in step 1610. In step 1615, the artificial intelligence engine 800 may reference historical data for each user to determine the timeframes which similar projects have been completed by each user. Using scheduling information and historical data, the artificial intelligence engine 800 and machine learning engine 900 determine a timeframe for each user and display the information to one or more users within the system.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for managing organization dataflows, comprising:
a database configured to store a plurality of data related to a project scope, personnel, and historical data;
an artificial intelligence system to receive the plurality of data to provide the plurality of data to a machine learning module to determine one or more suggested steps for completing the project; and
a scheduling module in operable communication with the machine learning module to receive scheduling information and compare the scheduling information with the historical data to determine a timeframe for completing the project for at least one of a plurality of users.

2. The system of claim 1, further comprising a project completion module to receive information related to a project and determine one or more suggested steps for completing the project and determine at least one task required to complete the project.

3. The system of claim 2, further comprising a task completion module to receive information related to a task and determine one or more suggested steps for completing the task.

4. The system of claim 1, further comprising a content manager to receive the plurality of data and distribute the plurality of data to a distribution engine.

5. The system of claim 4, wherein the distribution engine determines one or more outputs for the content, wherein the outputs include at least one of the following: one or more webpages, one or more media outlets, and one or more email systems.

6. The system of claim 5, wherein the plurality of users each perform one or more tasks during a project.

7. The system of claim 6, wherein a project management system receives status updates for each of the one or more tasks and transmits an output, via a communications engine in operable communication with a communications application.

8. The system of claim 7, wherein the artificial intelligence engine provides a template for information transmitted by the communications application.

9. The system of claim 8, wherein the plurality of data includes a priority level assigned to the project, wherein the priority level is analyzed by the artificial intelligence engine to determine the timeframe for completing the project.

10. A system for managing organization dataflows, comprising:
a database configured to store a plurality of data related to a project scope, personnel, and historical data received by a workflow subsystem configured to aggregate the plurality of data;
an artificial intelligence system to receive the plurality of data to provide the plurality of data to a machine learning module to determine one or more suggested steps for completing the project; and
a scheduling module in operable communication with the machine learning module to receive scheduling information and compare the scheduling information with the historical data to determine a timeframe for completing the project for at least one of a plurality of users.

11. The system of claim 10, further comprising a project completion module to receive information related to a project and determine one or more suggested steps for completing the project and determine at least one task required to complete the project.

12. The system of claim 11, further comprising a task completion module to receive information related to a task and determine one or more suggested steps for completing the task.

13. The system of claim 12, further comprising a content manager to receive the plurality of data and distribute the plurality of data to a distribution engine.

14. The system of claim 13, wherein the distribution engine determines one or more outputs for the content, wherein the outputs include at least one of the following: one or more webpages, one or more media outlets, and one or more email systems.

15. The system of claim 14, wherein the plurality of users each perform one or more tasks during a project.

16. The system of claim 15, wherein a project management system receives status updates for each of the one or more tasks and transmits an output, via a communications engine in operable communication with a communications application.

17. The system of claim 16, wherein the artificial intelligence engine provides a template for information transmitted by the communications application.

18. The system of claim 17, wherein the plurality of data includes a priority level assigned to the project, wherein the priority level is analyzed by the artificial intelligence engine to determine the timeframe for completing the project.

19. A method for managing organization dataflows and optimizing project management,
the method comprising the steps of:
receiving, via a database, a plurality of data related to a project scope, personnel, and historical data received by a workflow subsystem configured to aggregate the plurality of data;
determining, via an artificial intelligence system, a suggested set of steps to complete a task associated with the plurality of data;
transmitting the suggested steps to one or more users;
determining a timeframe for the completion of the task; and
transmitting at least one status update to the one or more users upon the receipt of a change in the timeframe for the completion of the task.

20. The method of claim 19, further comprising a machine learning engine to compare historical data to the plurality of data to determine an efficient task step and personnel to complete the task step.
